(19) United States
(12) Patent Application Publication
(10) Pub. No.: US 2021/0307300 A1
(43) Pub. Date: Oct. 7, 2021

(54) Bird-Friendly Water Fountain Apparatus

(71) Applicant: Patrick Carmel Lauchner, Reno, NV (US)

(72) Inventor: Patrick Carmel Lauchner, Reno, NV (US)

(21) Appl. No.: 17/219,616

(22) Filed: Mar. 31, 2021

Related U.S. Application Data
(60) Provisional application No. 63/004,265, filed on Apr. 2, 2020.

(51) Int. Cl. A01K 45/00; A01K 39/02

(52) U.S. Cl. CPC A01K 45/002; A01K 39/02

(57) ABSTRACT

A bird-friendly water fountain is an apparatus that intents to provide users a way of nurturing outdoor birds with a safe resting area and clean water. To accomplish this, the apparatus includes an arrangement of components that facilitates a ground-predator resistant mechanism that prevents ground creatures from reaching the top and potentially harming birds. Further, the apparatus including a fountain system and a resting perch area, that is eco-friendly and comfortable for migratory birds. Furthermore, the apparatus provides the user easy ways of draining water out of the fountain, and easy ways of filling water into the fountain. A plurality of levelling and tension adjusting components allow the user to maintain a leveled off fountain in areas when the ground is not flat or leveled. Additionally, a recording device mounted within the apparatus enables capturing of video/audio footages of birds coming onto the water fountain.

The current application claims a priority to the U.S. Provisional patent application Ser. No. 63/004,265 filed on Apr. 2, 2020.

### FIELD OF THE INVENTION

The present invention relates generally to a bird-friendly water fountain. More specifically, the present invention relates to a safe water fountain for outdoor birds, that can prevent large ground creatures such as a cat from climbing to the top of the fountain.

### BACKGROUND OF THE INVENTION

When it comes to providing water and resources to outdoor birds, it is an objective to make sure that outdoor birds are able to rest safely and drink clean water before the next destination the birds will fly to. Many times, wild birds may be thirsty and will go ground level such as lakes and river to nurture themselves with water. During these times, the birds that are ground level can possibly be in danger when ground predators are seeking to hunt these birds on the blindside as the birds are coming to ground level. Within suburban areas, suburban birds drink from puddles, gutters, or other small buildup of water that may be contaminated.

An objective of the present invention is to provide users a way of nurturing outdoor birds with a resting area and clean water. It is further an aim of the present invention to provide a safe landing area for outdoor birds. To accomplish this, the present invention comprises an arrangement of components that facilitates a ground-predator resistant mechanism that prevents ground creatures from reaching the top and potentially harming birds, such as a cat. Further, the present invention comprises a water fountain system, and a resting perch area, that are eco-friendly and comfortable for migratory birds. The present invention further enables easy ways of draining water out of the fountain, and filling water into the fountain. Furthermore, easy maneuverability for the user is enabled by means of wheels located beneath the bird fountain to facilitate safe draining. It is also important to note that the present invention comprises tension adjusting devices that allow the user to maneuver and maintain a leveled off fountain in areas when the ground is not flat or leveled. Additionally, the present invention comprises attachments such as a recording device mounted within a main receptacle for capturing video/audio footages of the birds coming to drink water from the present invention.

### BRIEF DESCRIPTION OF THE DRAWINGS

FIG. 1 is a top-front-left perspective view of the present invention.

FIG. 2 is a bottom-rear-right perspective view of the present invention.

FIG. 3 is a front elevational view of the present invention.

FIG. 4 is a left side elevational view of the present invention.

FIG. 5 is a top plan view of the present invention.

FIG. 6 is a sectional view of FIG. 5, taken along A-A′.

FIG. 7 is a sectional view of FIG. 5, wherein an inner tube is connected between the water base receptacle and the upper section.

FIG. 8 is a top-front-left perspective view, wherein a perch is mounted onto the upper section of the present invention.

FIG. 9 is a top-front-left perspective view, wherein a raised level of corks is perimetrically mounted within the outer basin.

FIG. 10 is front elevational view of the present invention, wherein a recording device is mounted within the base receptacle.

### DETAIL DESCRIPTIONS OF THE INVENTION

All illustrations of the drawings are for the purpose of describing selected versions of the present invention and are not intended to limit the scope of the present invention.

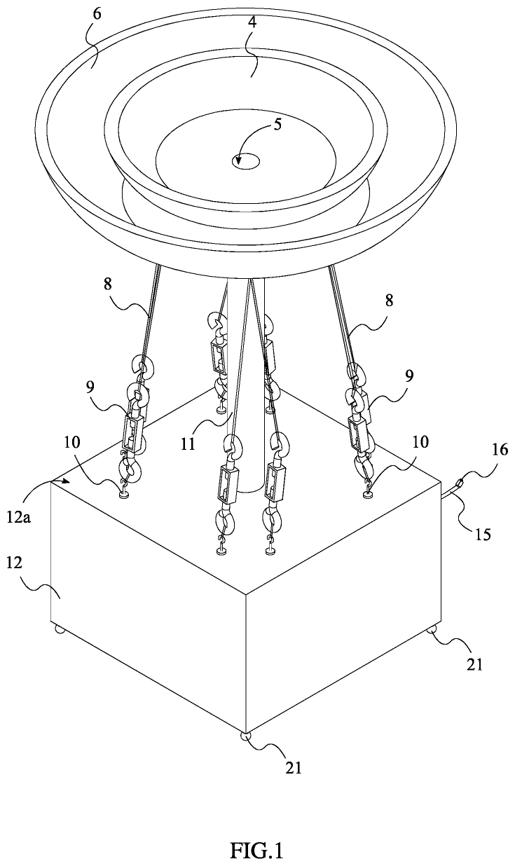

In reference to FIG. 1 through FIG. 10, the present invention is a bird-friendly water fountain. An objective of the present invention is to provide users a way of nurturing outdoor birds with a resting area and clean water. It is further an aim of the present invention to provide a safe landing area for outdoor birds. To accomplish this, the present invention comprises an arrangement of components that facilitates a ground-predator resistant mechanism that prevents ground creatures from reaching the top and potentially harming birds, such as a cat. Further, the present invention comprises a fountain system, and a resting perch area, that are eco-friendly and comfortable for migratory birds. The present invention further enables easy ways of draining water out of the fountain, and filling water into the fountain. Furthermore, easy maneuverability for the user is enabled by means of wheels located beneath the bird fountain to facilitate safe draining. It is also important to note that the present invention comprises tension adjusting devices that allow the user to maneuver and maintain a leveled off fountain in areas when the ground is not flat or leveled. Additionally, the present invention comprises additional attachments such as a recording device mounted within a main receptacle, for capturing video/audio footages of the birds coming to drink water from the present invention.

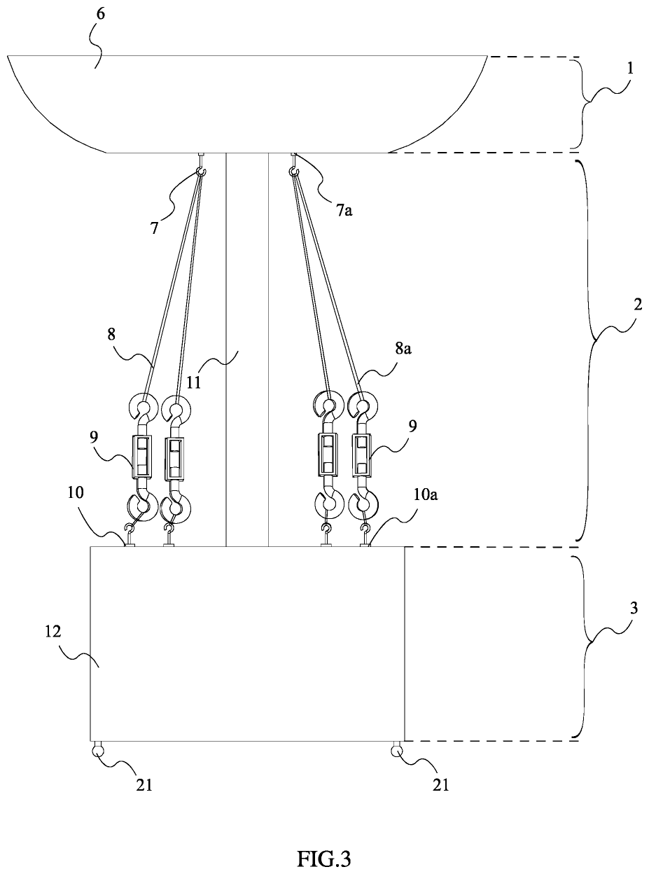

The following description is in reference to FIG. 1 through FIG. 10. According to a preferred embodiment of the present invention, the bird-friendly water fountain comprises an upper section 1, an intermediate section 2, and a lower section 3. In order to accomplish the smooth functioning of the apparatus, the intermediate section 2 is connected between the upper section 1 and the lower section 3, as seen in FIG. 3. In the preferred embodiment, the upper section 1 comprises an inner basin 4, an inner cavity 5, and an outer basin 6. Preferably, the inner basin 4 is used to hold water for outdoor birds, wherein a small water recirculating system or water fountain will be coupled thereof. As seen in FIG. 1, the inner basin 4 is positioned within the outer basin 6, and the inner cavity 5 traverses centrally into the inner basin 4. The inner cavity 5 acts as an opening spout for the water fountain system in the inner basin 4. In other words, water comes out and circulates through the inner cavity 5, thereby filling the inner basin 4 with clean water. Preferably, the outer basin 6 is used to hold physical debris such as rocks and sticks to aesthetically look natural for outdoor birds. Accordingly, the outer basin 6 acts as a safe landing area to allow birds to sit on without worry of ground predators. Further, both the inner basin 4 and the outer basin 6 may comprise any variety of physical debris and bird friendly components, as long as the intents of the present invention are not altered.

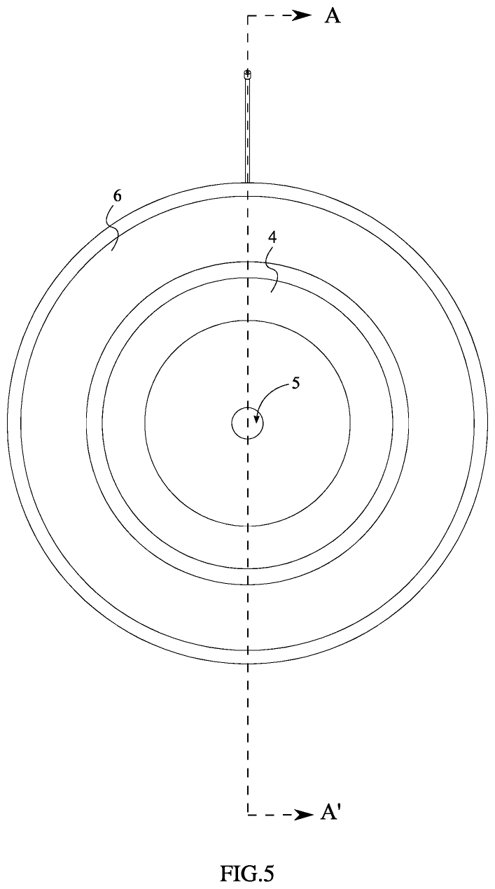

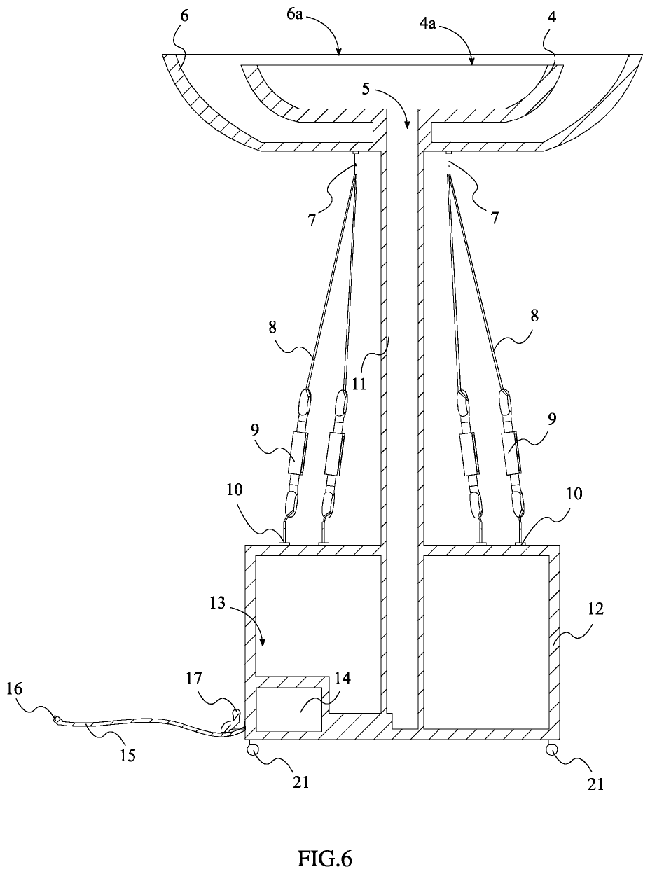

In the preferred embodiment, the inner basin 4 and the outer basin 6 are shaped like bowls, having circular transversal cross sections and comprises a sturdy material such as hard plastic, metal, terracotta etc. Further, the inner basin 4 is mounted centrally within the outer basin 6, as seen in FIG. 5. Furthermore, as seen in FIG. 6, a first edge 4a of the inner basin 4 is laterally offset from a second edge 6a of the outer basin 6. In other words, the top edge of the inner basin 4 is lower than the top edge of the outer basin 6. This is so that the outer basin 6 acts as a protective outer layer and helps the inner basin 4 with wind resistance, such that water in the inner basin 4 may not be blown away by wind. However, the inner basin 4 and the outer basin 6 may comprise any other material, size, shape, thickness, components and arrangement of components that are known to one of ordinary skill in the art, as long as the objectives of the present invention are fulfilled.

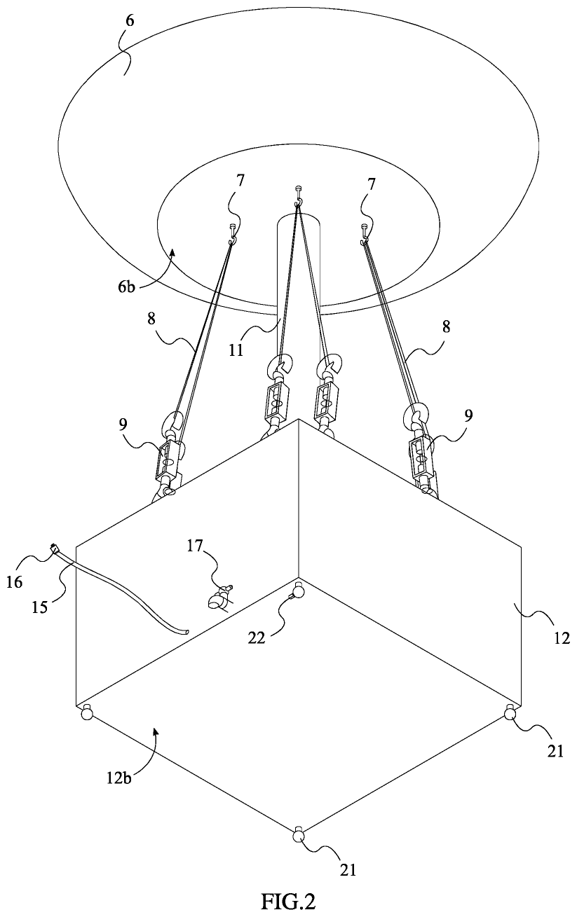

As seen in FIG. 1 through FIG. 4, the intermediate section 2 comprises a plurality of upper anchors 7, a plurality of cables 8, a plurality of tension adjusting devices 9, a plurality of lower anchors 10, and a connecting pipe 11. As seem in FIG. 2, the plurality of upper anchors 7 is mounted onto a lower surface 6b of the outer basin 6. Preferably, there are four upper anchors 7 on the lower surface 6b of the outer basin 6 and are evenly spread apart from one another. Further, the plurality of upper anchors 7 is mounted proximate to a center of the lower surface 6b of the outer basin 6, for stability. For achieving enough stability and maneuverability, the plurality of upper anchors 7 is used in unison with a plurality of tension adjusting devices 9 and the plurality of lower anchors 10. To that end, each of the plurality of cables 8 is engaged between a corresponding upper anchor 7a and a corresponding lower anchor 10a, wherein the corresponding upper anchor 7a is from the plurality of upper anchors 7 and the corresponding lower anchor 10a is from the plurality of lower anchors 10. In the preferred embodiment, there are eight vertical tension cables that provide physical deterrent to potentially any ground predator below, such as cats. However, within other embodiments of the present invention, the number of plurality of cables 8 may vary with the dependence in the size of the lower section 3. Furthermore, each of the plurality of tension adjusting devices 9 is integrated between a corresponding cable 8a, wherein the corresponding cable 8a is from the plurality of cables 8, such that the plurality of tension adjusting devices 9 are connected between the plurality of upper anchors 7 and the plurality of lower anchors 10. This is so that the plurality of cables 8, the tension adjusting devices 9, the upper anchors 7, and the lower anchors 10 provide a weight distribution and leveling for the water fountain as it allows significantly taller and thinner design with larger landing area. In other words, the combination of the upper anchors 7, the tension adjusting devices 9, the lower anchors 10, and the cables 8 allow the user to level off the fountain in areas when the ground is not flat or leveled. More specifically, the user is able to maneuver the tension adjusting devices 9 to tilt and re-level the inner basin 4 and the outer basin 6. The leveling of the inner basin 4 and the outer basin 6 reduce standing water on downhill side and reduces potential mosquito breeding areas. For example, the plurality of cables 8 work in unison with the upper anchors 7, the lower anchors 10, and the tension adjusting devices 9 to allow the user to re-level the inner basin 4 and outer basin 6 on uneven patios and/or gardens. Thus, the re-adjustability of the fountain level provides decreased risk of tipping during operation and moving of the fountain. As seen in FIG. 1 through FIG. 4, and FIG. 6 through FIG. 8, the plurality of tension adjusting devices 9 are turn buckles and the plurality of upper anchors 7 and lower anchors 10 are U-shaped hooks. However, the plurality of upper anchors 7, lower anchors 10 and the tension adjusting devices 9 may comprise any other shape, size, fastening mechanism, components and arrangement of components that are known to one of ordinary skill in the art, as long as the objectives of the present invention are not altered.

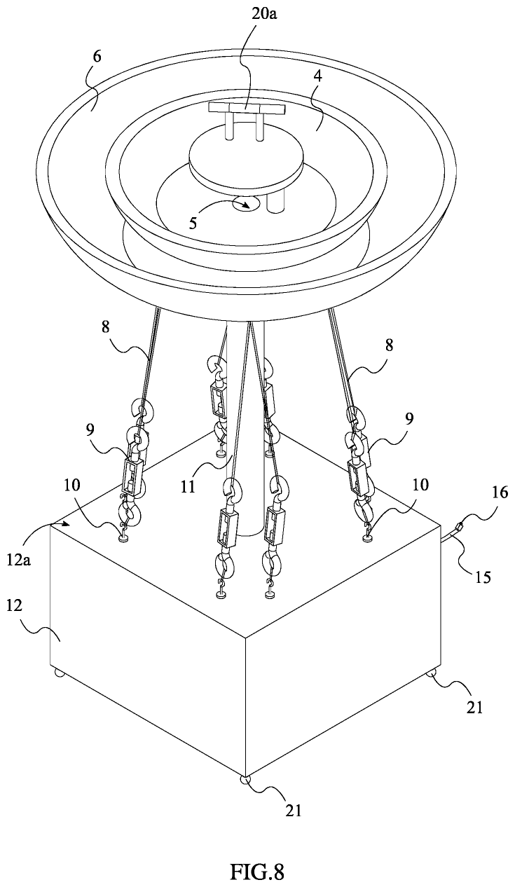

Continuing with the preferred embodiment of the present invention, the lower section 3 comprises a receptacle 12 and a water container 13, wherein the water container 13 is positioned within the receptacle 12. In the preferred embodiment, the receptacle 12 is shown to be a large rectangular-shaped box and the rectangular water container 13 housed within the receptacle 12, houses clean fresh water. As seen in FIG. 6, the receptacle 12 may be the water container 13 itself and/or two separate containers with similar dimensions. Alternately, as seen in FIG. 8, the water container 13 may be a separate smaller container placed within a larger receptacle 12. In such configurations/embodiments, the larger receptacle 12 may house other aesthetically pleasing and eco-friendly components such as trees, shrubs, twigs, bird feeders, etc. in the remaining free area. However, the receptacle 12 and the water container 13 may comprise any other shape, size, material etc. as long as the objectives of the present invention are not altered. As seen in FIG. 2, the plurality of lower anchors 10 is mounted onto the receptacle 12. More specifically, the plurality of lower anchors 10 is located on a top surface 12a of the receptacle adjacent an outer edge of the receptacle 12. In the preferred embodiment of the present invention, there are two lower anchors 10 per corner on the top surface 12a of the receptacle 12. However, the number of lower anchors 10 may vary with the dependence in the size of the receptacle 12. Further, the plurality of lower anchors 10 are evenly spread apart from one another as shown in FIG. 2.

It is an aim of the present invention to circulate clean water from the water container 13 to the upper section 1, for birds to drink from the inner basin 4. In order to accomplish this, the connecting pipe 11 is mounted normally and centrally between the inner basin 4 and the water container 13. The connecting pipe 11 is a cylindrical tube that protrudes straight up from the base of the water container 13 to the inner basin 4 as shown in FIG. 6. Preferably, the connecting pipe 11 is a vertical tube made of a hydrophobic material and comprise a wooden exterior finish. However, in an alternate embodiment, the connecting tube 11 may be a vertical tube that is clear and see-through, such that the user is able to visually check water quality from a distance. It should also be noted that the connecting pipe 11 may comprise any other shape, size or dimension, as long as the intents of the present invention are not hindered.

In order to pump water from the water container 13 into the inner basin 4 through the connecting pipe 11, the present invention comprises a pump 14. As seen in FIG. 6, the pump 14 is mounted within the receptacle 12, such that the pump 14 is in fluid communication with the water container 13. Further, the inner basin 4 is in fluid communication with the pump 14 through the inner cavity 5 and the connecting pipe 11, wherein the pump 14 induces a pressure differential that pushes water from the water container 13 into the inner basin 4. In other words, when the pump 14 is on, the pump 14 will take the water within the water container 13 and push it through the connecting pipe 11 which allow water to access the inner basin 4. Preferably, the pump 14 is a small water pump that can push water from the lower section 3 to the upper section 1. However, any other mechanism that is known to one of ordinary skill in the art may be employed to push water from the lower section 3 to the upper section 1, so as to enable the smooth functioning of the bird-friendly water fountain.

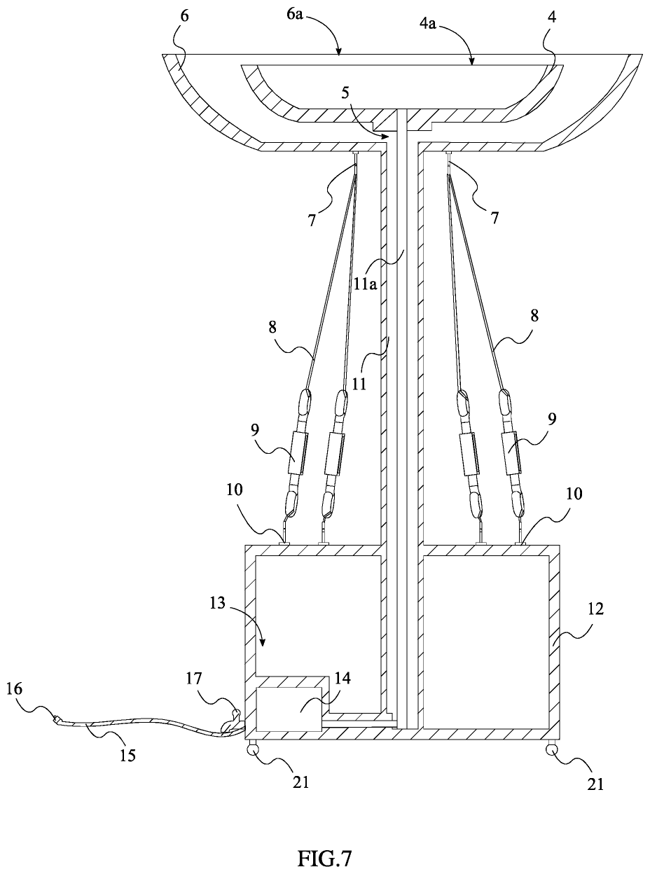

In reference to FIG. 7, an inner tube 11a may be mounted within the connecting pipe 11, such that the inner basin 4 is in fluid communication with the pump 14 through the inner tube 11a. This is so that water from the water container 13 may be pumped into the inner basin 4 through the inner tube 11a, and water may run back into the water container 13 through the connecting pipe 11. In other words, the inner basin 4 is in fluid communication with the pump 14, wherein the pump 14 induces a pressure differential that pushes water from the water container 13 into the inner basin 4 through the inner tube 11a. Preferably, the inner tube 11a is a cylindrical plastic tube. However, the inner tube 11a may comprise any other material, shape, size etc. as long as the objectives of the present invention are not altered. To enable this arrangement of water transfer, the outer basin 6 is in fluid communication with the water container 13 through the inner cavity 5 and the connecting pipe 11, wherein overflown water in the outer basin 6 falls down into the water container 13 through the inner cavity 5 and the connecting pipe 11. In other words, water overflows the inner basin 4 constantly and drops into the outer basin 6 for draining back into the connecting pipe 11. This arrangement enables water to be constantly replaced in the inner basin 4 like a flowing stream.

In order to provide power to the pump 14 and thereby enable the functioning of the water fountain, the present invention comprises a power cord 15. Accordingly, the power cord 15 is electrically coupled to the pump 14 and the power cord 15 is integrated into an outer surface of the receptacle 12. In the preferred embodiment, the power cord 15 is located on the rear face of the receptacle 12, such that the power cord 15 penetrates the rear face of the receptacle 12 adjacent a bottom end, as seen in FIG. 2. Preferably, a terminal end of the power cord comprising a plug 16, is inserted into an electrical outlet in order to give power to the pump 14 to allow the pump 14 to operate correctly. In other words, when the power cord 15 is inserted into an electrical outlet, power is provided to the pump 14 and the pump 14 is ready to be used. However, it should be noted that any other sources of power that are known to one of ordinary skill in the art may be employed for operating the found system, as long as the objectives of the present invention are not altered.

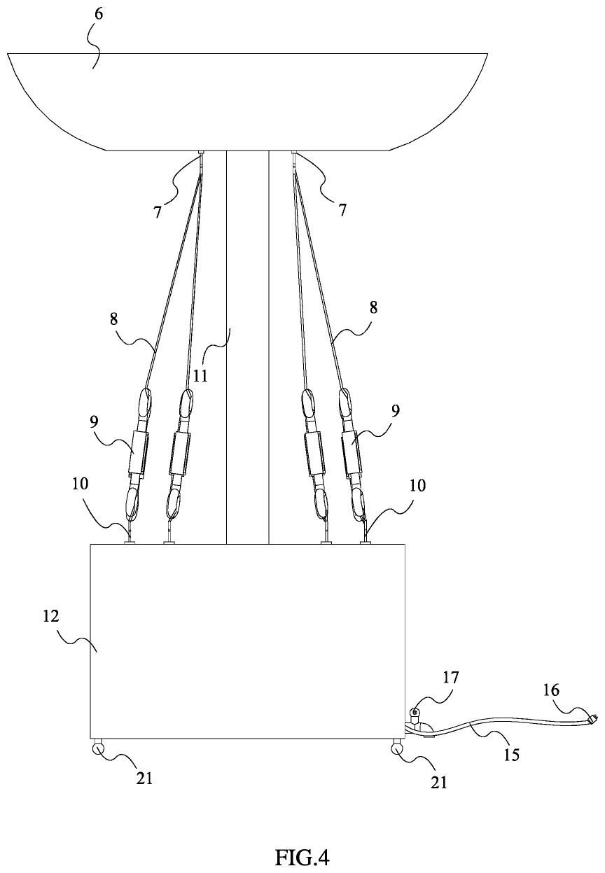

It is an aim of the present invention to provide users an easy way of draining water out of the fountain, and an easy way of filling water into the fountain. To that end, and in reference to FIG. 2, FIG. 3, FIG. FIG. 4 and FIG. 6, the present invention comprises a spigot 17. The spigot 17 is located on the rear end of the receptacle 12 to enable dispensing and draining of water from the water container 13. To accomplish easy draining, the spigot 17 is integrated into the outer surface of the water container 13 and the receptacle 12. In other words, the spigot 17 allows the user to dispense and drain water out of the water container 13, thereby allowing the user to dispose dirty water for benefits of cleanliness of the fountain and health of the birds. However, the water container 13 may be drained by inserting a tube in the center of the inner cavity 5. This arrangement enables the pump 14 to push water out the tube and the user may use that water, to water trees and plants. Further, the water container 13 may be filled with a hose at the same time, allowing water to be cleaned and replaced without complete draining.

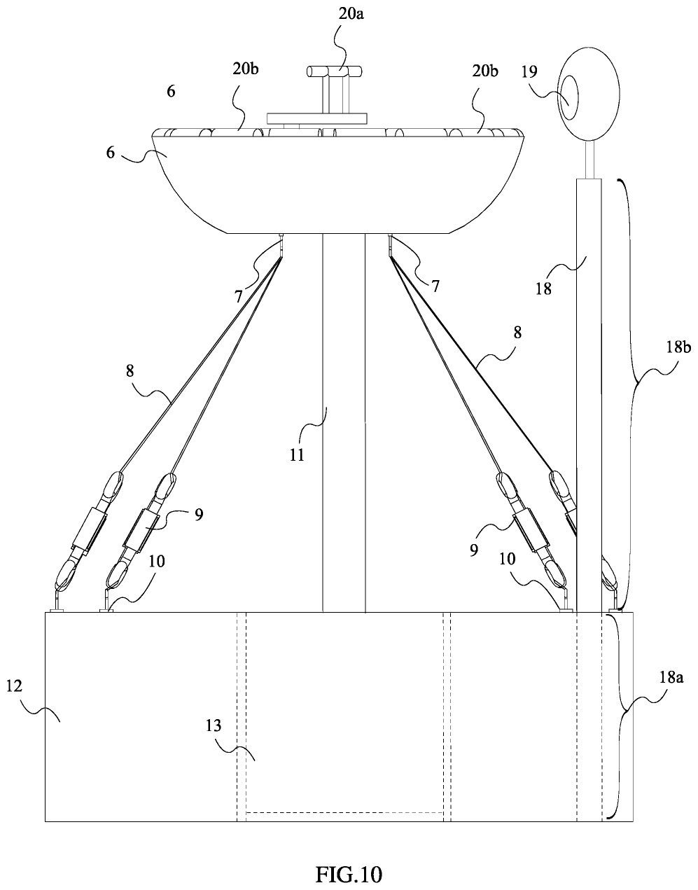

In order to obtain audio/video footages of the wide variety of migratory or regional birds that come to the water fountain, the present invention comprises a pole 18 and a recording device 19. As seen in FIG. 10, a first section 18a of the pole 18 is normally mounted within the receptacle 12, and a second section 18b of the pole 18 extends normally out of the receptacle 12. Preferably, the recording device 19 is mounted adjacent a terminal end of the second section 18b, such that the recording device 19 is oriented toward the upper section 1 of the present invention. Further, the design of the pole 18 prevents larger ground animals from climbing up to the recording device 19 and damaging it.

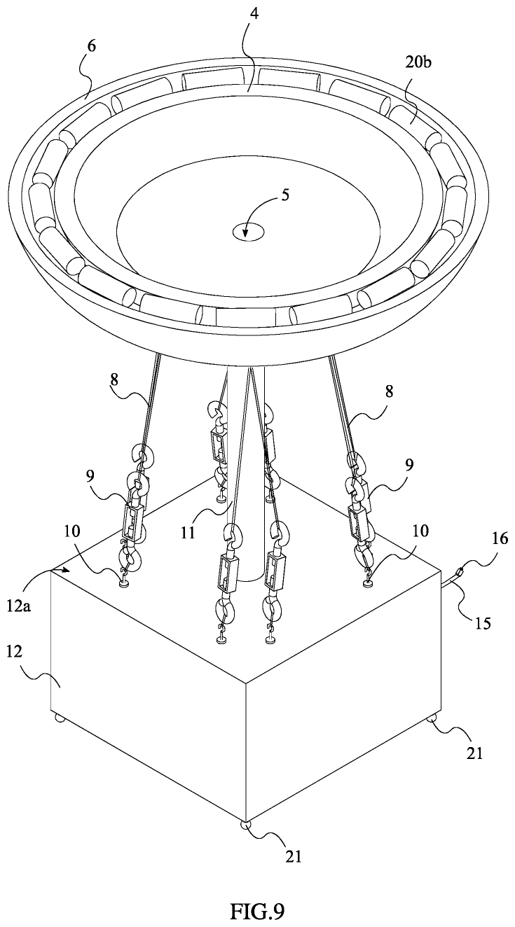

In reference to FIG. 8 and FIG. 10, the present invention comprises a perch 20a. Preferably, the perch 20a is mounted over at least one of, the inner basin 4 and the outer basin 6, such that different varieties of birds can comfortably rest and drink water from the inner basin 4. In the preferred embodiment, the perch 20a is mounted within the inner basin 4, adjacent the inner cavity 5. However, the perch 20a may comprise any other shape, size, material, orientation, location, components and arrangement of components that are known to one of ordinary skill in the art, as long as the intents of the present invention are not altered. Further, as seen in FIG. 9 and FIG. 10, the outer basin 6 may comprise other bird friendly surfaces such as a raised rim of corks, wooden dowels etc., such that they are easier on the birds' feet. Accordingly, a plurality of corks 20b are perimetrically mounted within the outer basin 6. In order for the plurality of corks 20b to be on a raised level above the second edge 6a of the outer basin 6, another layer of corks or other solid substances may be placed within the outer basin 6. Furthermore, sufficient gap is left between the plurality of corks 20b for water drainage.

In reference to FIG. 1 through FIG. 8, the present invention comprises a plurality of wheels 21 and a locking mechanism 22. Preferably, the plurality of wheels 21 is perimetrically mounted onto a bottom surface 12b of the receptacle 12. In other words, the plurality of wheels 21 is located on the corners of the bottom surface 12b of the receptacle 12 and are evenly spread apart from one another as shown in FIG. 2. The plurality of wheels 21 provides mobility for the present invention and they allow the user to move the present invention to a desired location with ease. Preferably, the locking mechanism 22 is integrated onto at least one of the plurality of wheels 21, and the locking mechanism 22 prevent the wheels from rolling. Further, the locking mechanism 22 allows the present invention to be locked in a stationary position for stability purposes. Thus, the present invention is a bird-friendly, eco-friendly, user-friendly, and efficient outdoor water fountain.

Although the invention has been explained in relation to its preferred embodiment, it is to be understood that many other possible modifications and variations can be made without departing from the spirit and scope of the invention as hereinafter claimed.

What is claimed is:

1. A bird-friendly water fountain apparatus comprising:
an upper section;
an intermediate section;
a lower section;
the upper section comprising an inner basin, an inner cavity, and an outer basin;
the intermediate section comprising a plurality of upper anchors, a plurality of cables, a plurality of tension adjusting devices, a plurality of lower anchors, and a connecting pipe;
the lower section comprising a receptacle and a water container;
the intermediate section being connected between the upper section and the lower section;
the inner basin being positioned within the outer basin;
the inner cavity traversing centrally into the inner basin;
the plurality of upper anchors being mounted onto a lower surface of the outer basin;
the plurality of lower anchors being mounted onto the-receptacle;
each of the plurality of cables being engaged between a corresponding upper anchor and a corresponding lower anchor, wherein the corresponding upper anchor is from the plurality of upper anchors and the corresponding lower anchor is from the plurality of lower anchors;
each of the plurality of tension adjusting devices being integrated between a corresponding cable, wherein the corresponding cable is from the plurality of cables;
the water container being positioned within the receptacle; and
the connecting pipe being mounted normally and centrally between the inner basin and the water container.

2. The bird-friendly water fountain apparatus of claim 1, comprising:
a pump;
the pump being mounted within the receptacle; and
the inner basin being in fluid communication with the pump through the inner cavity and the connecting pipe, wherein the pump induces a pressure differential that pushes water from the water container into the inner basin.

3. The bird-friendly water fountain apparatus of claim 2, comprising:
an inner tube;
the inner tube being mounted within the connecting pipe;
the inner basin being in fluid communication with the pump, wherein the pump induces a pressure differential that pushes water from the water container into the inner basin through the inner tube; and
the outer basin being in fluid communication with the water container through the inner cavity and the connecting pipe, wherein overflown water in the outer basin falls down into the water container through the inner cavity and the connecting pipe.

4. The bird-friendly water fountain apparatus of claim 2, comprising:
a power cord;
the power cord being electrically coupled to the pump; and
the power cord being integrated into an outer surface of the receptacle.

5. The bird-friendly water fountain apparatus of claim 1, comprising:
a pole;
a recording device;
a first section of the pole being normally mounted within the receptacle;
a second section of the pole extending normally out of the receptacle;
the recording device being mounted adjacent a terminal end of the second section; and
the recording device being oriented toward the upper section.

6. The bird-friendly water fountain apparatus of claim 1, comprising:
a spigot;
the spigot being integrated into the outer surface of the water container.

7. The bird friendly water fountain apparatus of claim 1, comprising:
a perch;
the perch being mounted over at least one of the inner basin and the outer basin.

8. The bird-friendly water fountain apparatus of claim 1, comprising:
a plurality of wheels;
a locking mechanism;
the plurality of wheels being perimetrically mounted onto a bottom surface of the receptacle; and
the locking mechanism being integrated onto at least one of the plurality of wheels.

9. The bird-friendly water fountain apparatus of claim 1, wherein the inner basin is mounted centrally within the outer basin.

10. The bird-friendly water fountain apparatus of claim 1, wherein the plurality of lower anchors is mounted adjacent an outer edge of the receptacle.

11. The bird-friendly water fountain apparatus of claim 1, wherein the plurality of upper anchors is mounted proximate to a center of the lower surface of the outer basin.

12. The bird-friendly water fountain apparatus of claim 1, wherein the inner basin and the outer basin have circular transversal cross sections.

13. The bird-friendly water fountain apparatus of claim 1, wherein a first edge of the inner basin is laterally offset from a second edge of the outer basin.

14. The bird-friendly water fountain apparatus of claim 1, comprising:
a plurality of corks; and
the plurality of corks being perimetrically mounted within the outer basin.

15. A bird-friendly water fountain apparatus comprising:
an upper section;
an intermediate section;
a lower section;
the upper section comprising an inner basin, an inner cavity, and an outer basin;
the intermediate section comprising a plurality of upper anchors, a plurality of cables, a plurality of tension adjusting devices, a plurality of lower anchors, and a connecting pipe;
the lower section comprising a receptacle and a water container, and a pump;
the intermediate section being connected between the upper section and the lower section;
the inner basin being positioned within the outer basin;
the inner cavity traversing centrally into the inner basin;
the plurality of upper anchors being mounted onto a lower surface of the outer basin;
the plurality of lower anchors being mounted onto the-receptacle;
each of the plurality of cables being engaged between a corresponding upper anchor and a corresponding lower anchor, wherein the corresponding upper anchor is from the plurality of upper anchors and the corresponding lower anchor is from the plurality of lower anchors;
each of the plurality of tension adjusting devices being integrated between a corresponding cable, wherein the corresponding cable is from the plurality of cables;
the water container being positioned within the receptacle;
the connecting pipe being mounted normally and centrally between the inner basin and the water container;
the pump being mounted within the receptacle; and
the inner basin being in fluid communication with the pump through the inner cavity and the connecting pipe, wherein the pump induces a pressure differential that pushes water from the water container into the inner basin.

16. The bird-friendly water fountain apparatus of claim 15, comprising:
a power cord;
the power cord being electrically coupled to the pump; and
the power cord being integrated into an outer surface of the receptacle.

17. The bird-friendly water fountain apparatus of claim 15, comprising:
a pole;
a recording device;
a first section of the pole being normally mounted within the receptacle;
a second section of the pole extending normally out of the receptacle;
the recording device being mounted adjacent a terminal end of the second section; and
the recording device being oriented toward the upper section.

18. The bird-friendly water fountain apparatus of claim 15, comprising:
a spigot; and
the spigot being integrated into the outer surface of the water container.

19. The bird friendly water fountain apparatus of claim 15, comprising:
a perch; and
the perch being mounted over at least one of the inner basin and the outer basin.

20. The bird-friendly water fountain apparatus of claim 15, wherein a first edge of the inner basin is laterally offset from a second edge of the outer basin.
